(19) United States
(12) Patent Application Publication
(10) Pub. No.: US 2022/0081320 A1
(43) Pub. Date: Mar. 17, 2022

(54) RESIDENTIAL RETROFIT BRINE RECLAMATION SYSTEM

(71) Applicant: Water Control Corporation, Ramsey, MN (US)

(72) Inventor: Brian Soderholm, Ramsey, MN (US)

(73) Assignee: Water Control Corporation, Ramsey, MN (US)

(21) Appl. No.: 17/447,636

(22) Filed: Sep. 14, 2021

Related U.S. Application Data
(60) Provisional application No. 63/077,898, filed on Sep. 14, 2020.

(51) Int. Cl. C02F 1/00; C02F 5/00

(52) U.S. Cl. CPC C02F 1/008; C02F 5/00; C02F 2303/16; C02F 2201/005; C02F 2209/03; C02F 2209/40

(57) ABSTRACT

A residential retrofit brine reclamation system includes a brine reclamation control panel; a flow sensor; and a three-way valve. The control panel includes a controller with an adjustable timer. The flow sensor is electrically connected to the controller and is connected to a tee fitting via a push-connect fitting with tubing. The three-way valve is electrically connected to the controller and has a softener effluent inlet, a brine water return outlet, and a drain outlet. A method of brine reclamation includes installing the brine reclamation system onto a resin tank and a brine tank and programming the controller to set a regeneration cycle time. The system identifies the start of a regeneration mode by sensing a flow in a softener brine line and directs softener effluent into the valve inlet. After draining some of the softener effluent, the system closes the drain outlet and opens the brine tank return outlet.

### CROSS-REFERENCE TO RELATED APPLICATION

This application claims the benefit of priority of U.S. provisional application No. 63/077,898, filed Sep. 14, 2020, the contents of which are herein incorporated by reference.

### BACKGROUND OF THE INVENTION

The present invention relates to water softeners and, more particularly, to a residential retrofit brine reclamation system.

Water softeners discharge large volumes of salt (chlorides) into the wastewater stream during regeneration. This is both financially wasteful and harmful to rivers, lakes, streams, groundwater, wastewater treatment plants, and septic systems.

Other systems for brine reclamation (recycling) require a site-built system of valves that must be tied into an existing commercial softener valve. Some residential systems are available but are specific to a single manufacturer/series.

Residential homes generally do not have the commercial-grade softener valves required for a site-built brine reclamation system. Additionally, the single brand/series of residential units sold with this feature built-in are both expensive and not widely available in the marketplace.

Currently existing brine reclamation systems are for commercial use only—or require the purchase of a specially designed water softener valve.

As can be seen, there is a need for a residential retrofit brine reclamation system.

### SUMMARY OF THE INVENTION

The present invention provides the first completely retrofittable Brine Reclamation system for residential water softeners. It enables a user to improve on their existing system without replacing an existing softener with a very specific, expensive, model. The inventive system reduces salt (chloride) usage during softener regeneration cycles by approximately 35%. Any existing residential softener may be retrofitted with the inventive system to provide significant salt savings and environmental benefit.

In one aspect of the present invention, a residential retrofit brine reclamation system is provided, comprising: a brine reclamation control panel with a controller having an adjustable timer; a flow sensor electrically connected to the controller, said flow sensor being connected to a tee fitting by way of a push-connect fitting and to tubing; and a three-way valve electrically connected to the controller; wherein the three-way valve has a softener effluent inlet, a brine water return outlet, and a drain outlet.

The controller may be selected from the group consisting of a printed circuit board (PCB) controller, a programmable logic controller (PLC), and a combination thereof.

In another aspect of the present invention, a method of brine reclamation with a retrofit residential water softener, comprising: a brine reclamation system onto a resin tank and a brine tank, the brine reclamation system comprising a controller, a 3-way motorized valve, and a flow sensor; programming the controller to set a regeneration cycle time comprising a sum of a first predetermined time, a second predetermined time, and a third predetermined time; identifying a start of a water softener regeneration mode by sensing a flow in a softener brine line; directing softener effluent into an inlet on the 3-way motorized valve; opening a drain outlet and closing a brine tank return outlet on the 3-way motorized valve for the first predetermined time such that spent brine is directed to a drain; closing the drain outlet and opening the brine tank return outlet for the second predetermined time such that the spent brine is directed to the brine tank; and opening the drain outlet and closing the brine tank return outlet for the third predetermined time such that spent brine is directed to the drain.

These and other features, aspects and advantages of the present invention will become better understood with reference to the following drawings, description, and claims.

### BRIEF DESCRIPTION OF THE DRAWINGS

FIG. 1 is a schematic diagram of a system according to an embodiment of the present invention;

FIG. 2 is a detail schematic diagram indicated; and

FIG. 3 is another schematic diagram shown the flow directions.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, one embodiment of the present invention is a retrofit brine reclamation system for residential water softeners. It diverts viable salt water (brine) back to the salt (brine) tank for a period of minutes during a brine & rinse cycle. After several minutes, salt water (brine) is directed back to a drain, which is the default configuration. The system comprises a controller with a pressure sensor and tee connector, a three-way motorized valve, and tubing.

A method of using the inventive retrofit residential water softener brine reclamation system may include installing the system by mounting a water-resistant electrical enclosure, or housing, on a wall next to an existing water softener or on a side of a brine tank. The enclosure generally contains a printed circuit board (PCB) controller, a pressure transducer, and an output, such as a 24V output, to a 3-way motorized valve. In some embodiments, the motorized 3-way valve may also be contained inside the electrical enclosure. In some embodiments, the system may mount on a softener control valve or on a softener resin tank. A tee may be used to connect the pressure transducer to an existing softener brine line between the resin tank and the brine tank. The tee may be connected to the pressure transducer with push-connect fitting on the enclosure having a size substantially matching the outer diameter of the tubing. For example, the fitting may be about ⅜″ for tubing having an outer diameter (OD) of about ⅜″. A drain or effluent outlet from the water softener may be connected to the 3-way motorized valve inlet (i.e., the softener effluent inlet). A drain line outlet of the 3-way motorized valve may be connected to a drain via tubing. A brine tank return outlet of the 3-way motorized valve may be connected back into the brine tank via tubing and a simple barbed fitting. The tubing may be secured with compression fittings coupled to the valve for water-tight connections with the drain line, brine tank return (reclamation) line, softener drain outlet, and 3-way motorized valve. For example, the fittings may be about ⅝″ OD×½″ national pipe thread (NPT). The alternating current (AC) power adaptor may be connected to a power supply and to the PCB controller which receives electrical supply via a 120-volt alternating current (VAC) to 24-volt direct current (VDC) plug-in transformer.

The materials of manufacture are not particularly limited provided that the result is to code. The tubing may be made of any suitable polymer. In some embodiments, the tubing may be replaced with solid piping, for example, plastic or metal.

The system may be used as follows. The user may program the controller/timer so that system operation timing corresponds to the water softener regeneration cycle timing, enabling the system to pair with any residential softener. The controller sends power signals to the 3-way auto return motorized valve, based on the pre-programmed, adjustable timer sequence. The 3-way auto return motorized valve directs brine water exiting the softener resin tank via an existing softener drain line either to the drain or back to the brine tank for further use (i.e., reclamation).

Detection of vacuum in brine line via the pressure transducer tells the controller that a brine draw cycle of softener regeneration has commenced. When the flow of brine solution is detected via the pressure transducer, the controller assembly is activated, actuating the reclamation process, and begins counting down. When the water softener goes into regeneration mode, the effluent brine water drains into the 3-way motorized valve inlet. After several minutes, the 3-way auto return motorized valve is de-energized, causing it to revert to its default position. At this point, the unit is deactivated. Spent brine water is sent to the drain again, and the softener finishes its default regeneration process.

In some embodiments, the 3-way motorized valve may be replaced with 2 individual valves—one defaulting to open and one defaulting to closed.

In some embodiments, the pressure transducer may be replaced with another means of sensing brine line flow, such as a flow sensor selected from the group consisting of a vacuum switch, a flow switch, a flow meter, and a liquid sensor.

In some embodiments, additional elements may include audible and visual alarms and hardware for Wi-Fi and/or building automation connectivity.

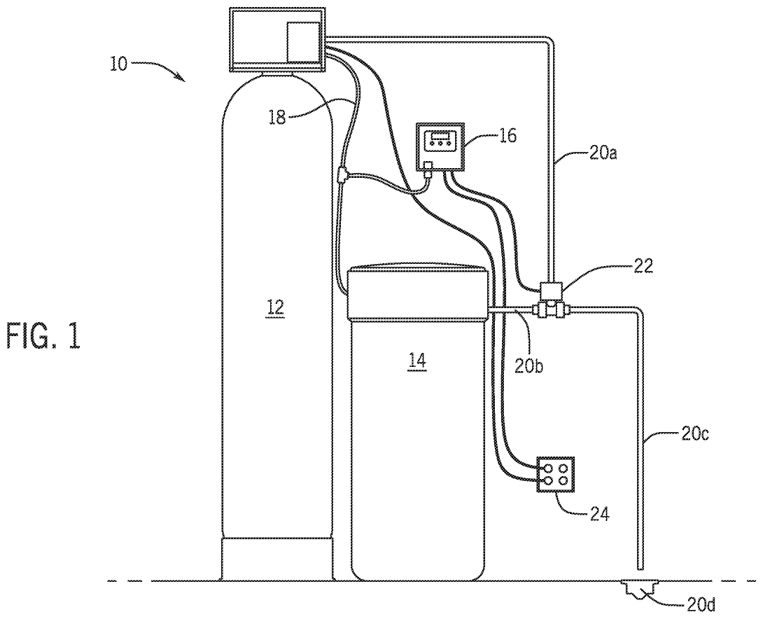

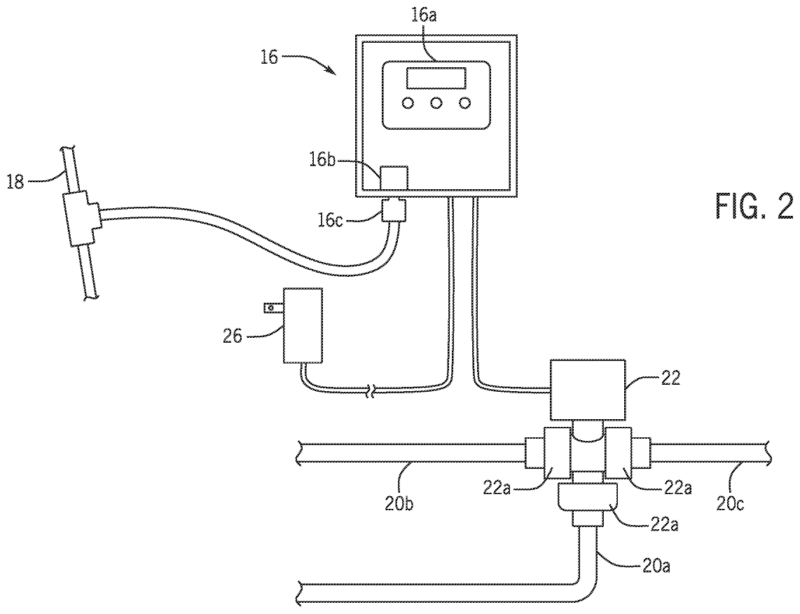

Referring to FIGS. 1 through 3, FIG. 1 shows a brine reclamation system 10 comprising a water softener 12 and a brine tank 14. The system 10 is controlled with a brine reclamation control panel 16, directing flow through a brine line 18, a drain line 20a to three-way motorized valve 22, a brine water return line 20b to brine tank 14, and a drain line 20c which discharges to a floor drain 20d. The brine reclamation control panel 16 and the three-way motorized valve 22 are shown in more detail in FIG. 2. The control panel 16 includes a PCB controller 16a, a PCB-mounted pressure transducer 16b, and a push-to-connect fitting 16c, leading to the brine line 18. The valve 22 has three fittings 22a, one for the softener effluent line 20a, one for the brine water return outlet 20b, and one for the drain line 20c. The valve 22 is electrically connected to the controller 16a.

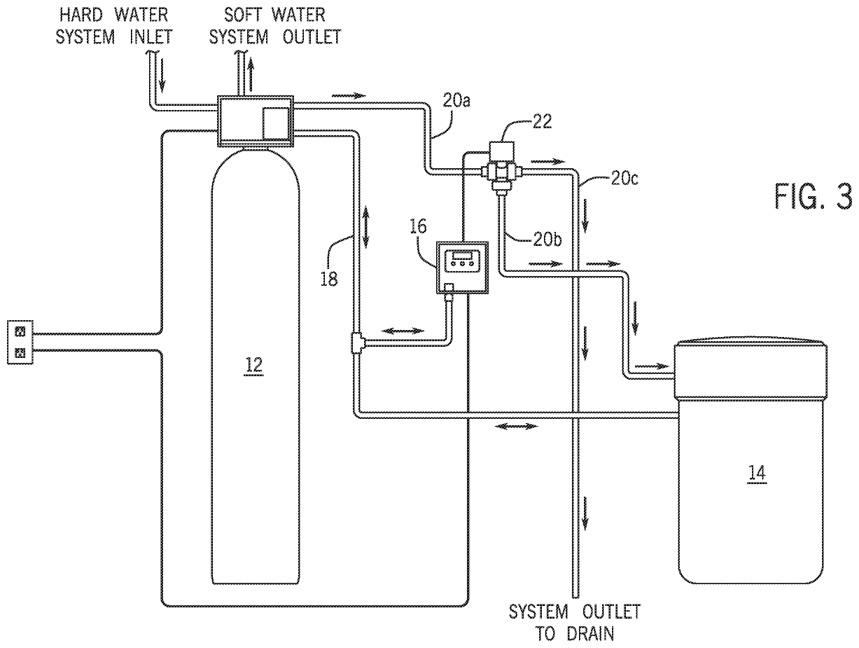

FIG. 3 shows the flow of fluid throughout the system in operation. Hard water enters via an inlet and soft water is discharged via an outlet. When the water softener 12 begins regeneration mode, the effluent brine water flows out of the softener effluent line 20a and into the 3-way motorized valve 22 inlet.

During a backwash cycle of softener regeneration that lasts for a period of minutes, i.e., a first third of a brine & rinse cycle, the 3-way motorized valve 22 drain outlet 20c is open and the brine tank return outlet 20b is closed. The spent brine is directed from the 3-way motorized valve 22 directly out to the drain 20d (see FIG. 1) via line 20c.

During a second third of the regeneration cycle, the PCB control assembly sends an electrical signal to the 3-way auto return motorized valve 22, the 3-way motorized valve drain outlet 20c is energized closed, and the brine tank return outlet 20b is energized open, causing it to redirect the spent brine water back to the brine tank 14 for reuse (reclamation).

During a last third of the regeneration cycle, the 3-way motorized valve 22 drain line outlet 20c is again opened, and brine tank return outlet 20b is closed. During the Rapid Rinse cycle of softener 12 regeneration, effluent 20a is directed into the 3-way motorized valve 22 and directly out to the drain 20d.

The regeneration cycle then continues per individual softener 12 programming.

In the final phase of regeneration, the brine tank 14 is refilled with an amount of water recommended by the manufacturer, less the amount of brine water that is reclaimed per regeneration (approximately ⅓).

It should be understood, of course, that the foregoing relates to exemplary embodiments of the invention and that modifications may be made without departing from the spirit and scope of the invention as set forth in the following claims.

What is claimed is:

1. A residential retrofit brine reclamation system, comprising:
a brine reclamation control panel with a controller having an adjustable timer; a flow sensor electrically connected to the controller, said flow sensor being connected to a tee fitting by way of a push-connect fitting with tubing; and a three-way valve electrically connected to the controller; wherein the three-way valve has a softener effluent inlet, a brine water return outlet, and a drain outlet.

2. The residential retrofit brine reclamation system of claim 1, wherein the flow sensor is selected from the group consisting of: a pressure transducer, a vacuum switch, a flow switch, a flow meter, and a liquid sensor.

3. The residential retrofit brine reclamation system of claim 1, wherein the three-way valve has a fitting coupled to the softener effluent inlet, a fitting coupled to the brine water return outlet, and a fitting coupled to the drain outlet.

4. The residential retrofit brine reclamation system of claim 1, wherein the three-way valve is motorized.

5. The residential retrofit brine reclamation system of claim 1, further comprising a housing, wherein the brine reclamation control panel, and the flow sensor are mounted within the housing.

6. The residential retrofit brine reclamation system of claim 1, wherein the controller is selected from the group consisting of a printed circuit board controller, a programmable logic controller, and a combination thereof.

7. A method of brine reclamation with a retrofit residential water softener, comprising:
a. installing a brine reclamation system onto a resin tank and a brine tank, the brine reclamation system comprising a controller, a 3-way motorized valve, and a flow sensor;
b. programming the controller to set a regeneration cycle time comprising a sum of a first predetermined time, a second predetermined time, and a third predetermined time;
c. identifying a start of a water softener regeneration mode by sensing a flow in a softener brine line;
d. directing softener effluent into an inlet on the 3-way motorized valve;
e. opening a drain outlet and closing a brine tank return outlet on the 3-way motorized valve for the first predetermined time such that spent brine is directed to a drain;
f. closing the drain outlet and opening the brine tank return outlet for the second predetermined time such that the spent brine is directed to the brine tank; and
g. opening the drain outlet and closing the brine tank return outlet for the third predetermined time such that spent brine is directed to the drain.

8. The method of brine reclamation with a retrofit residential water softener of claim 7, wherein the controller is selected from the group consisting of a printed circuit board controller, a programmable logic controller, and a combination thereof.
